(19) United States
(12) Patent Application Publication
(10) Pub. No.: US 2016/0264839 A1
(43) Pub. Date: Sep. 15, 2016

(54) WELL CEMENT COMPOSITION INCLUDING MULTI-COMPONENT FIBERS AND METHOD OF CEMENTING USING THE SAME

(71) Applicant: 3M INNOVATIVE PROPERTIES COMPANY, Saint Paul, MN (US)

(72) Inventors: Clara E. Mata, Lindstrom, MN (US); Yong K. Wu, Woodbury, MN (US); Ignatius A. Kadoma, Cottage Grove, MN (US); Michael D. Crandall, North Oaks, MN (US); Amor A. Calubayan, Woodbury, MN (US); Andrew J. Peterson, White Bear Lake, MN (US)

(21) Appl. No.: 15/031,448

(22) PCT Filed: Oct. 22, 2014
(86) PCT No.: PCT/US2014/061727

§ 371 Date: Apr. 22, 2016

Related U.S. Application Data
(60) Provisional application No. 61/894,214, filed on Oct. 22, 2013.

(51) Int. Cl. C09K 8/467; C04B 28/04; E21B 33/14; C04B 16/12

(52) U.S. Cl. CPC C09K 8/467; C04B 16/12; C04B 28/04; E21B 33/14; C09K 2208/08

(57) ABSTRACT

A well cement composition includes a hydraulic well cement and multi-component fibers having at least a first polymeric composition and a second polymeric composition. At least a portion of the external surfaces of the multi-component fibers includes the first polymeric composition, and the first polymeric composition includes an ethylene-methacrylic acid or ethylene-acrylic acid copolymer. A method of cementing a subterranean well is also described. The method includes introducing the well cement composition into a wellbore, wherein the well cement composition further comprises water, and forming a cured cement in the wellbore.

### BACKGROUND

Well cementing in the construction of an oil or gas well, which is also called primary cementing, is the process of mixing and displacing a cement slurry down the casing (steel pipe) and up the annular space behind the casing. Once in place, the cured cement has three principal functions in the well: (1) to restrict fluid movement between formations, (2) to bond the casing to the formation, and (3) to provide support for the casing. Other uses for cement in oil and gas wells include remedial cementing applications such as squeeze cementing, sealing a lost circulation zone, plugging a well at a location for initiating sidetracking to bore a lateral well, and plugging a well so that it may be shut down.

For cement to perform satisfactorily, sufficient strength must be developed in the cement to avoid mechanical failure, the cement must be stable enough that will not deteriorate, decompose, or otherwise lose its qualities of strength for the duration of its intended use, and the cement must be sufficiently impermeable so that fluids cannot flow through it when it is set. Consequences of a failure in any of these can be serious. According to an article at http://www.pennenergy.com/articles/pennenergy/2012/03/faulty-wells-not.html entitled “Faulty wells, not fracking, responsible for water contamination,” Southwestern Energy Co. determined that flawed cement can allow natural gas, whether produced through fracking or not, to seep up into more porous rock and from there into groundwater. Mechanical failure of cement caused by stresses in an oil or gas well is typically tensile in nature.

In unrelated technologies, certain fibers have been proposed to improve the mechanical properties of concrete. See, for example, U.S. Pat. No. 4,801,630 (Chow et al.) and U.S. Pat. No. 6,844,065 (Reddy et al.), Int. Pat. App. Pub. No. WO94/20654 (Bergstrom et al.), and Japanese Pat. App. Pub. Nos. Hei-Sei 9-255391 (published Sep. 30, 1997), JP11255544 (published Sep. 21, 1999), and JP2009084101 (published Apr. 23, 2009).

### SUMMARY

The present disclosure includes a well cement composition including multi-component fibers and a method of cementing using such a composition. The well cement composition and method of cementing can be useful for primary cementing and remedial cementing. The multi-component fibers may be useful, for example, for improving the tensile strength of well cement. The multi-component fibers may also be useful, for example, for increasing the flexural strength of well cement. Furthermore, the multi-component fibers may be useful, for example, for adhesively bonding a cured cement even after a fracture in the cement is initiated.

In one aspect, the present disclosure provides a well cement composition that includes a hydraulic well cement and multi-component fibers having at least a first polymeric composition and a second polymeric composition. At least a portion of the external surfaces of the multi-component fibers includes the first polymeric composition, and the first polymeric composition includes an ethylene-methacrylic acid or ethylene-acrylic acid copolymer.

In another aspect, the present disclosure provides a method of cementing a subterranean well. The method includes introducing the well cement composition, which further comprises water, into a wellbore and forming a cured cement in the wellbore.

In some embodiments of the method of cementing the subterranean well, the wellbore has a casing within it, and introducing the well cement composition comprises placing the cement in the annular space between the casing and the wellbore. Accordingly, in another aspect the present disclosure provides a cased hole made according to this method.

In some embodiments, the multi-component fibers in the well cement composition according to the present disclosure provide a better tensile strength improvement in hydraulic well cement than other multi-component fibers (e.g., those having polyolefin sheaths or those having sheaths with other polar groups).

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g. 1 to 5 includes 1, 1.5, 2, 2.75, 3, 3.80, 4, and 5).

The term “hydraulic well cement” will be understood to have the art-recognized meaning of a composition that is employed in various aspects of well drilling and cementing operations and in which hydraulic cement constitutes one of the ingredients.

A percentage “based on the weight of cement” or “BWOC” means that the weight of a component is calculated by multiplying the weight of the neat cement by a percentage. This is different from describing the weight percent of a component based on the solids in the well cement composition.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

For a more complete understanding of the features and advantages of the present disclosure, reference is now made to the detailed description along with the accompanying figures and in which:

FIGS. 1A-1D are schematic cross-sections of four exemplary multi-component fibers useful in well cement compositions according to the present disclosure; and

FIGS. 2A-2E are schematic perspective views of various multi-component fibers useful in well cement compositions according to the present disclosure.

### DETAILED DESCRIPTION

Multi-component (e.g., bi-component) fibers can generally be made using techniques known in the art. Such techniques include fiber spinning (see, e.g., U.S. Pat. No. 4,406,850 (Hills), U.S. Pat. No. 5,458,972 (Hagen), U.S. Pat. No. 5,411,693 (Wust), U.S. Pat. No. 5,618,479 (Lijten), and U.S. Pat. No. 5,989,004 (Cook)). For any of the embodiments of multi-component fibers useful in the well cement compositions and methods disclosed herein, the first polymeric composition may be a single polymeric material (that is, an ethylene-methacrylic acid or ethylene-acrylic acid copolymer), a blend of polymeric materials including the ethylene-methacrylic acid or ethylene-acrylic acid copolymer, or a blend of the ethylene-methacrylic acid or ethylene-acrylic acid copolymer and at least one other additive. Each component of the fibers, including the first polymeric composition, second polymeric composition, and any additional polymers, can be selected to provide desirable performance characteristics.

In some embodiments, multi-component fibers useful in the methods of cementing a subterranean well are advantageously non-fusing at temperatures encountered in the well while the subterranean formation is being cemented, which may be in a range from 80° C. to 200° C., for example. In some embodiments, multi-component fibers useful for the well cement composition and/or method according to the present disclosure are non-fusing at a temperature of at least 110° C. (in some embodiments, at least 120° C., 125° C., 150° C., or even at least 160° C.). In some embodiments, the multi-component fibers are non-fusing at a temperature of up to 200° C. “Non-fusing” fibers can autogenously bond (i.e., bond without the addition of pressure between fibers) without significant loss of architecture, for example, a core-sheath configuration. The spatial relationship between the first polymeric composition, the second polymeric composition, and optionally any other component of the fiber is generally retained in non-fusing fibers. Many multi-component fibers (e.g., fibers with a core-sheath configuration) undergo so much flow of the sheath composition during autogenous bonding that the core-sheath structure is lost as the sheath composition becomes concentrated at fiber junctions and the core composition is exposed elsewhere. Such multi-component fibers are fusing fibers. The multi-component fibers useful for practicing the present disclosure include a first polymeric composition that makes up at least a portion of the external surface of the fibers and may at least partially adhesively bond the cured cement. In non-fusing fibers, heat causes little or no flow of the first polymeric composition so that the adhesive function may extend along external surface of the majority of the multi-component fibers. The loss of structure in fusing fibers may cause this adhesive function to be concentrated at the fiber junctions. Because of this, non-fusing fibers may be more effective at adhesively bonding and providing strength improvement in cured cement than fusing fibers.

To evaluate whether fibers are non-fusing at a particular temperature, the following test method is used. The fibers are cut to 6 mm lengths, separated, and formed into a flat tuft of interlocking fibers. The larger cross-sectional dimension (e.g., the diameter for a circular cross-section) of twenty of the cut and separated fibers is measured and the median recorded. The tufts of the fibers are heated in a conventional vented convection oven for 5 minutes at the selected test temperature. Twenty individual separate fibers are then selected and their larger cross-section dimension (e.g., diameter) measured and the median recorded. The fibers are designated as “non-fusing” if there is less than 20% change in the measured dimension after the heating.

In some embodiments, the first polymeric composition in the multi-component fibers using for practicing the present disclosure has a softening temperature of up to 150° C. (in some embodiments, up to 140° C., 130° C., 120° C., 110° C., 100° C., 90° C., 80° C., or 70° C. or in a range from 80° C. to 150° C.). The softening temperature of the first polymeric composition is determined using a stress-controlled rheometer (Model AR2000 manufactured by TA Instruments, New Castle, Del.) according to the following procedure. A sample of the first polymeric composition is placed between two 20 mm parallel plates of the rheometer and pressed to a gap of 2 mm ensuring complete coverage of the plates. A sinusoidal frequency of 1 Hz at 1% strain is then applied over a temperature range of 80° C. to 200° C. The resistance force of the molten resin to the sinusoidal strain is proportional to its modulus which is recorded by a transducer and displayed in graphical format. Using rheometeric software, the modulus is mathematically split into two parts: one part that is in phase with the applied strain (elastic modulus—solid-like behavior), and another part that is out of phase with the applied strain (viscous modulus—liquid-like behavior). The temperature at which the two moduli (elastic and viscous) are identical (the cross-over temperature) is the softening temperature, as it represents the temperature above which the resin begins to behave predominantly like a liquid.

The softening temperature of the first polymeric composition, advantageously, may be above the storage temperature of the multi-component fiber. The desired softening temperature can be achieved by selecting an appropriate single polymeric material or combining two or more polymeric materials. For example, if a polymeric material softens at too high of a temperature, the softening temperature can be decreased by adding a second polymeric material with a lower softening temperature. Also, a polymeric material may be combined with, for example, a plasticizer to achieve the desired softening temperature.

In the well cement composition and method according to the present disclosure, the first polymeric composition comprises an ethylene-methacrylic acid or ethylene-acrylic acid copolymer. In some embodiments, the first polymeric composition is an ethylene-methacrylic acid or ethylene-acrylic acid copolymer. In some embodiments, the acrylic acid or methacrylic acid is at least partially neutralized when the multi-component fibers are prepared. In some embodiments, the first polymeric composition in the multi-component fiber comprises a partially neutralized ethylene-methacrylic acid copolymer commercially available, for example, from E. I. duPont de Nemours & Company, Wilmington, Del., under the trade designations “SURLYN 8660,” “SURLYN 1702,” “SURLYN 1857,” and “SURLYN 9520”) and from Dow Chemical Company, Midland, Mich., under the trade designation “AMPLIFY”. In other embodiments, the acrylic acid or methacrylic acid is at least partially neutralized at the time when the multi-component fibers are combined with the hydraulic well cement composition, which typically has an alkaline pH. This means that in these embodiments, the acrylic acid or methacrylic acid groups in the first polymeric composition are not neutralized when the fiber is made but become at least partially neutralized when the fibers are incorporated into the alkaline well cement composition. Examples of suitable ethylene-acrylic acid copolymers include those available, for example, from Dow Chemical Company under the trade designation “PRIMACOR”, and examples of suitable ethylene-methacrylic acid copolymers include those available, for example, from E. I. duPont de Nemours & Company under the trade designation “NUCREL”.

Examples of polymers that may be combined with the ethylene-methacrylic acid or ethylene-acrylic acid copolymer include at least one of (i.e., includes one or more of the following in any combination) ethylene-vinyl alcohol copolymer (e.g., with softening temperature of 156° C. to 191° C., available from EVAL America, Houston, Tex., under the trade designation “EVAL G176B”), thermoplastic polyurethane (e.g., available from Huntsman, Houston, Tex., under the trade designation “IROGRAN A80 P4699”), polyoxymethylene (e.g., available from Ticona, Florence, KY, under the trade designation “CELCON FG40U01”), polypropylene (e.g., available from Total, Paris, France, under the trade designation “5571”), polyolefins (e.g., available from ExxonMobil, Houston, Tex., under the trade designation “EXACT 8230”), ethylene-vinyl acetate copolymer (e.g., available from AT Plastics, Edmonton, Alberta, Canada), polyester (e.g., available from Evonik, Parsippany, N.J., under the trade designation “DYNAPOL” or from EMS-Chemie AG, Reichenauerstrasse, Switzerland, under the trade designation “GRILTEX”), polyamides (e.g., available from Arizona Chemical, Jacksonville, Fla., under the trade designation “UNIREZ 2662” or from E. I. du Pont de Nemours under the trade designation “ELVAMIDE 8660”), phenoxy (e.g., from Inchem, Rock Hill S.C.), vinyls (e.g., polyvinyl chloride form Omnia Plastica, Arsizio, Italy), or acrylics (e.g., from Arkema, Paris, France, under the trade designation “LOTADEREX 8900”). In some embodiments, the first polymeric composition does not comprise a polyolefin (that is, a polyolefin that is not copolymerized with acrylic acid or methacrylic acid). In some embodiments, the combination of the ethylene-methacrylic acid or ethylene-acrylic acid copolymer and any resin with which it is combined has a softening temperature up to 150° C. (in some embodiments, up to than 140° C., 130° C., 120° C., 110° C., 100° C., 90° C., 80° C., or 70° C. or in a range from 80° C. to 150° C.). In some embodiments, multi-component fibers useful for practicing the present disclosure may comprise in a range from 5 to 85 (in some embodiments, 5 to 40, 40 to 70, or 60 to 70) percent by weight of the first polymeric composition.

In some embodiments of multi-component fibers useful in the well cement composition and method according to the present disclosure, the first polymeric composition has an elastic modulus of less than 3×10⁵ N/m² at a frequency of about 1 Hz at a temperature encountered in the well while the subterranean formation is being cemented, which may be at a temperature of at least 80° C. In these embodiments, typically the first polymeric composition is tacky at the temperature of 80° C. and above. In some embodiments of the well cement composition and/or method according to the present disclosure, the first polymeric composition has an elastic modulus of less than 3×10⁵ N/m² at a frequency of about 1 Hz at a temperature of at least 85° C., 90° C., 95° C., or 100° C. For any of these embodiments, the elastic modulus is measured using the method described above for determining softening temperature except the elastic modulus is determined at the selected temperature (e.g., 80° C., 85° C., 90° C., 95° C., or 100° C.). The tackiness of the first polymeric composition at a temperature of at least 80° C. can serve to adhere the multi-component fibers to each other and the cured cement. In some embodiments, the first polymeric composition is designed to be tacky at a specific downhole temperature (e.g., the bottomhole static temperature (BHST). A tacky network may be formed almost instantaneously when the fibers reach their desired position in the formation, providing the possibility of quick development of adhesion in the cured cement.

In some embodiments of multi-component fibers useful in the methods of cementing a subterranean well disclosed herein, the second polymeric composition has a melting point that is above the temperature encountered in the well while the subterranean formation is being cemented, which may be in a range from 80° C. to 200° C. For example, the melting point may be at least 10° C., 15° C., 20° C., 25° C., 50° C., 75° C., or at least 100° C. above the temperature in the formation. In some embodiments of multi-component fibers useful in a well cement composition and/or method according to the present disclosure, the melting point of the second polymeric composition is at least 130° C. (in some embodiments, at least 140° C. or 150° C.; in some embodiments, in a range from 160° C. to 220° C.). Examples of useful second polymeric compositions include at least one of (i.e., includes one or more of the following in any combination) a polyamide (e.g., available from E. I. du Pont de Nemours under the trade designation “ELVAMIDE” or from BASF North America, Florham Park, N.J., under the trade designation “ULTRAMID”), polyester (e.g., available from Evonik under the trade designation “DYNAPOL” or from EMS-Chemie AG under the trade designation “GRILTEX”), polyimide, polyetheretherketone, or polyphenylenesulfide. In some embodiments, the second polymeric composition is not a polyolefin. In some embodiments, the second polymeric composition does not include a polyolefin. Polyolefins tend to have lower tensile strength than the examples of second polymeric compositions described above. As described above for the first polymeric compositions, blends of polymers and/or other components can be used to make the second polymeric compositions. For example, a thermoplastic having a melting point of less than 130° C. can be modified by adding a higher-melting thermoplastic polymer. In some embodiments, the second polymeric composition is present in a range from 5 to 40 percent by weight, based on the total weight of the multi-component fiber. The melting temperature is measured by differential scanning calorimetry (DSC). In cases where the second polymeric composition includes more than one polymer, there may be two melting points. In these cases, the melting point of at least 130° C. is the lowest melting point in the second polymeric composition.

Typically, multi-component fibers useful in the well cement composition and/or the method according to the present disclosure exhibit at least one of (in some embodiments both) hydrocarbon or hydrolytic resistance. Hydrocarbon and/or hydrolytic resistance can be useful, for example, for the multi-component fibers to be stable in the cement composition including water described above and in the environment encountered in the well being drilled. In some embodiments, when a 5 percent by weight mixture of the plurality of fibers in deionized water is heated at 145° C. for four hours in an autoclave, less than 50% by volume of the plurality of fibers at least one of dissolves or disintegrates, and less than 50% by volume of the first polymeric composition and the curable resin at least one of dissolves or disintegrates. Specifically, hydrolytic resistance is determined using the following procedure. One-half gram of fibers is placed into a 12 mL vial containing 10 grams of deionized water. The vial is nitrogen sparged, sealed with a rubber septum and placed in an autoclave at 145° C. for 4 hours. The fibers are then subjected to optical microscopic examination at 100× magnification. They are deemed to have failed the test if either at least 50 percent by volume of the fibers or at least 50 percent by volume of the either the first polymeric composition or second polymeric composition dissolved and/or disintegrated as determined by visual examination under the microscope.

In some embodiments, when a 2 percent weight to volume mixture of the plurality of fibers in kerosene is heated at 145° C. for 24 hours under nitrogen, less than 50% by volume of the plurality of fibers at least one of dissolves or disintegrates, and less than 50% by volume of the first polymeric composition and the second polymeric composition at least one of dissolves or disintegrates. Specifically, hydrocarbon resistance is determined using the following procedure. One-half gram of fibers is placed into 25 mL of kerosene (reagent grade, boiling point 175° C.-320° C., obtained from Sigma-Aldrich, Milwaukee, Wis.), and heated to 145° C. for 24 hours under nitrogen. After 24 hours, the kerosene is cooled, and the fibers are examined using optical microscopy at 100× magnification. They are deemed to have failed the test if either at least 50 percent by volume of the fibers or at least 50 percent by volume of the first polymeric composition or the second polymeric composition dissolved and/or disintegrated as determined by visual examination under the microscope.

Multi-component fibers useful in the well cement compositions and methods disclosed herein can have a variety of cross-sectional shapes. Useful fibers include those having at least one cross-sectional shape selected from the group consisting of circular, prismatic, cylindrical, lobed, rectangular, polygonal, or dog-boned. The fibers may be hollow or not hollow, and they may be straight or have an undulating shape. Differences in cross-sectional shape allow for control of active surface area, mechanical properties, and interaction with other well cement components. In some embodiments, the fiber useful for practicing the present disclosure has a circular cross-section or a rectangular cross-section. Fibers having a generally rectangular cross-section shape are also typically known as ribbons. Fibers are useful, for example, because they provide large surface areas relative the volume they displace.

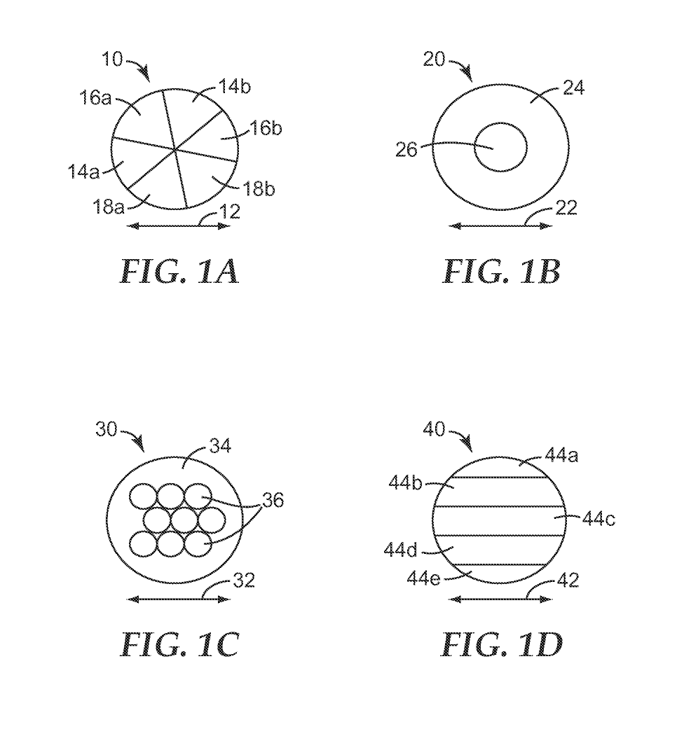

Examples of multi-component fibers useful for practicing the present disclosure include those with cross-sections illustrated in FIGS. 1A-1D. A core-sheath configuration, as shown in FIG. 1B or 1C, may be useful, for example, because of the large surface area of the sheath. In these configurations, the external surface of the fiber is typically made from a single polymeric composition. It is within the scope of the present disclosure for the core-sheath configurations to have multiple sheaths. Other configurations, for example, as shown in FIGS. 1A and 1D provide options that can be selected depending on the intended application. In the segmented pie wedge (see, e.g., FIG. 1A) and the layered (see, e.g., FIG. 1D) configurations, typically the external surface is made from more than one composition.

Referring to FIG. 1A, a pie-wedge fiber 10 has a circular cross-section 12, a first polymeric composition located in regions 16a and 16b, and a second polymeric composition located in regions 14a and 14b. Other regions in the fiber (18a and 18b) may include a third component (e.g., a third, different polymeric composition having a melting point of at least 140° C.) or may independently include the first polymeric composition or the second polymeric composition.

In FIG. 1B, fiber 20 has circular cross-section 22, sheath 24 of a first polymeric composition, and core 26 of a second polymeric composition. FIG. 1C shows fiber 30 having a circular cross-section 32 and a core-sheath structure with sheath 34 of a first polymeric composition and plurality of cores 36 of a second polymeric composition.

FIG. 1D shows fiber 40 having circular cross-section 42, with five layered regions 44a, 44b, 44c, 44d, 44e, which comprise alternatively at least the first polymeric composition and the second polymeric composition. Optionally, a third, different polymeric composition may be included in at least one of the layers.

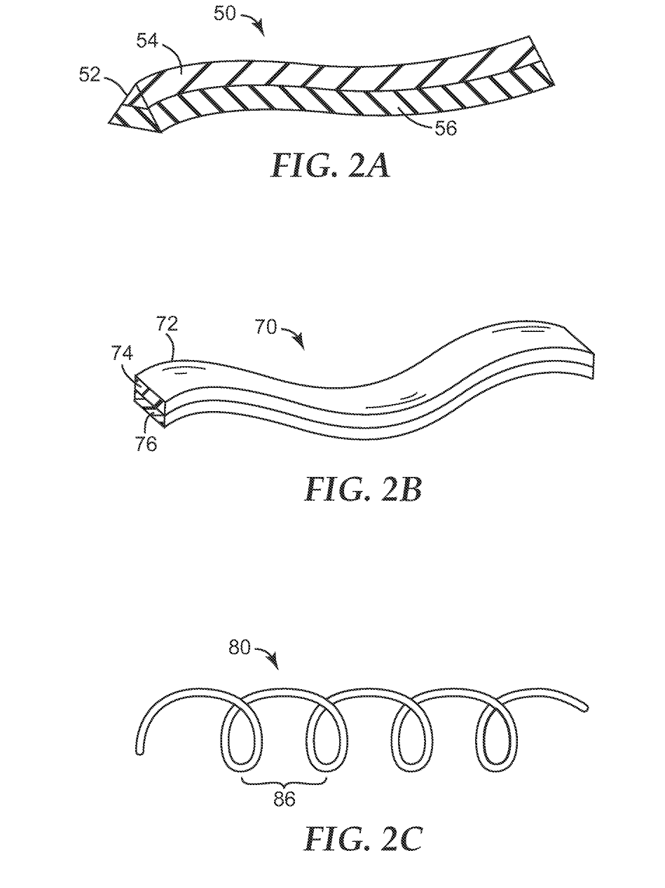

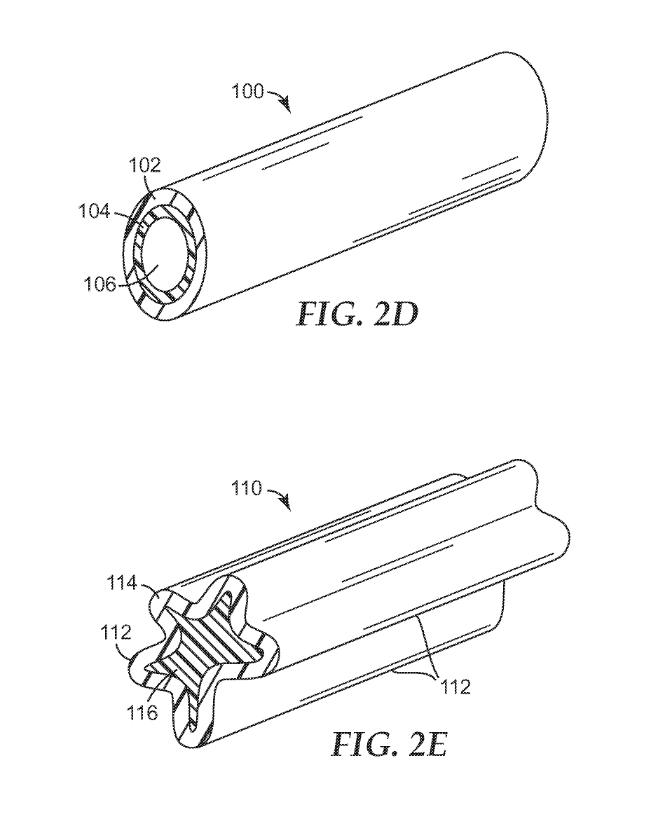

FIGS. 2A-2E illustrate perspective views of various embodiments of multi-component fibers useful for practicing the present disclosure. FIG. 2A illustrates a fiber 50 having a triangular cross-section 52. In the illustrated embodiment, the first polymeric composition 54 exists in one region, and the second polymeric composition 56 is positioned adjacent the first polymeric composition 54.

FIG. 2B illustrates a ribbon-shaped embodiment 70 having a generally rectangular cross-section and an undulating shape 72. In the illustrated embodiment, a first layer 74 comprises the first polymeric composition, while a second layer 76 comprises the second polymeric composition.

FIG. 2C illustrates a coiled or crimped multi-component fiber 80 useful for articles according to the present disclosure. The distance between coils, 86, may be adjusted according to the properties desired.

FIG. 2D illustrates a fiber 100 having a cylindrical shape, and having a first annular component 102, a second annular component 104, the latter component defining hollow core 106. The first and second annular components typically comprise the first polymeric composition and the second polymeric composition, respectively. The hollow core 106 may optionally be partially or fully filled with an additive (e.g., a tackifier for one of the annular components 102, 104).

FIG. 2E illustrates a fiber with a lobed-structure 110, the example shown having five lobes 112 with outer portions 114 and an interior portion 116. The outer portions 114 and interior portion 116 typically comprise the first polymeric composition and the second polymeric composition, respectively.

The aspect ratio (that is, length to diameter or width) of multi-component fibers useful in the well cement compositions and method disclosed herein may be, for example, at least 3:1, 4:1, 5:1, 10:1, 25:1, 50:1, 75:1, 100:1, 150:1, 200:1, 250:1, 500:1, 1000:1, or more; or in a range from 2:1 to 1000:1. Larger aspect ratios (e.g., having aspect ratios of 10:1 or more) may more easily allow the formation of a network of multi-component fibers and may allow for more area of the cement to be adhered to the external surfaces of the fibers.

Multi-component fibers useful in the well cement compositions and method according to the present disclosure include those having a length up to 60 millimeters (mm), in some embodiments, in a range from 2 mm to 60 mm, 3 mm to 40 mm, 2 mm to 30 mm, or 3 mm to 20 mm. Typically, the multi-component fibers disclosed herein have a maximum cross-sectional dimension up to 100 (in some embodiments, up to 90, 80, 70, 60, 50, 40, or 30) micrometers. For example, the fiber may have a circular cross-section with an average diameter in a range from 1 micrometer to 100 micrometers, 1 micrometer to 60 micrometers, 10 micrometers to 50 micrometers, 10 micrometers to 30 micrometers, or 17 micrometers to 23 micrometers. In another example, the fibers may have a rectangular cross-section with an average length (i.e., longer cross-sectional dimension) in a range from 1 micrometer to 100 micrometers, 1 micrometer to 60 micrometers, 10 micrometers to 50 micrometers, 10 micrometers to 30 micrometers, or 17 micrometers to 23 micrometers.

Typically, the dimensions of the multi-component fibers used together in the well cement compositions and method according to the present disclosure and components making up the fibers are generally about the same, although use of fibers with even significant differences in compositions and/or dimensions may also be useful. In some applications, it may be desirable to use two or more different types of multi-component fibers (e.g., at least one different polymer or resin, one or more additional polymers, different average lengths, or otherwise distinguishable constructions), where one group offers a certain advantage(s) in one aspect, and other group a certain advantage(s) in another aspect.

Optionally, fibers useful for practicing the present disclosure may further comprise other components (e.g., additives and/or coatings) to impart desirable properties such as handling, processability, stability, and dispersability. Examples of additives and coating materials include antioxidants, colorants (e.g., dyes and pigments), fillers (e.g., carbon black, clays, and silica), and surface applied materials (e.g., waxes, surfactants, polymeric dispersing agents, talcs, erucamide, gums, and flow control agents) to improve handling.

Surfactants can be used to improve the dispersibility or handling of multi-component fibers described herein. Useful surfactants (also known as emulsifiers) include anionic, cationic, amphoteric, and nonionic surfactants. Useful anionic surfactants include alkylarylether sulfates and sulfonates, alkylarylpolyether sulfates and sulfonates (e.g., alkylarylpoly(ethylene oxide) sulfates and sulfonates, in some embodiments, those having up to about 4 ethyleneoxy repeat units, including sodium alkylaryl polyether sulfonates such as those known under the trade designation “TRITON X200”, available from Rohm and Haas, Philadelphia, Pa.), alkyl sulfates and sulfonates (e.g., sodium lauryl sulfate, ammonium lauryl sulfate, triethanolamine lauryl sulfate, and sodium hexadecyl sulfate), alkylaryl sulfates and sulfonates (e.g., sodium dodecylbenzene sulfate and sodium dodecylbenzene sulfonate), alkyl ether sulfates and sulfonates (e.g., ammonium lauryl ether sulfate), and alkylpolyether sulfate and sulfonates (e.g., alkyl poly(ethylene oxide) sulfates and sulfonates, in some embodiments, those having up to about 4 ethyleneoxy units). Useful nonionic surfactants include ethoxylated oleoyl alcohol and polyoxyethylene octylphenyl ether. Useful cationic surfactants include mixtures of alkyl dimethylbenzyl ammonium chlorides, wherein the alkyl chain has from 10 to 18 carbon atoms. Amphoteric surfactants are also useful and include sulfobetaines, N-alkylaminopropionic acids, and N-alkylbetaines. Surfactants may be added to the fibers disclosed herein, for example, in an amount sufficient on average to make a monolayer coating over the surfaces of the fibers to induce spontaneous wetting. Useful amounts of surfactants may be in a range, for example, from 0.05 to 3 percent by weight, based on the total weight of the multi-component fiber.

Polymeric dispersing agents may also be used, for example, to promote the dispersion of fibers described herein in a chosen fluid, and at the desired application conditions (e.g., pH and temperature). Exemplary polymeric dispersing agents include salts (e.g., ammonium, sodium, lithium, and potassium) of polyacrylic acids of greater than 5000 average molecular weight, carboxy modified polyacrylamides (available, for example, under the trade designation “CYANAMER A-370” from Cytec Industries, West Paterson, N.J.), copolymers of acrylic acid and dimethylaminoethylmethacrylate, polymeric quaternary amines (e.g., a quaternized polyvinyl-pyrollidone copolymer (available, for example, under the trade designation “GAFQUAT 755” from ISP Corp., Wayne, N.J.) and a quaternized amine substituted cellulosic (available, for example, under the trade designation “JR-400” from Dow Chemical Company), cellulosics, carboxy-modified cellulosics (e.g., sodium carboxy methycellulose (available, for example, under the trade designation ““NATROSOL CMC Type 7L” from Hercules, Wilmington, Del.), and polyvinyl alcohols. Polymeric dispersing agents may be added to the fibers disclosed herein, for example, in an amount sufficient on average to make a monolayer coating over the surfaces of the fibers to induce spontaneous wetting. Useful amounts of polymeric dispersing agents may be in a range, for example, from 0.05 to 5 percent by weight, based on the total weight of the fiber.

Examples of antioxidants include hindered phenols (available, for example, under the trade designation “IRGANOX” from Ciba Specialty Chemical, Basel, Switzerland). Typically, antioxidants are used in a range from 0.1 to 1.5 percent by weight, based on the total weight of the fiber, to retain useful properties during extrusion.

In some embodiments, multi-component fibers useful in the well cement composition and method according to the present disclosure may be crosslinked, for example, through radiation or chemical means. That is, at least one of the first polymeric composition or second polymeric composition may be crosslinked before the fibers are added to the well cement composition. Chemical crosslinking can be carried out, for example, by incorporation of thermal free radical initiators, photoinitiators, or ionic crosslinkers. When exposed to a suitable wavelength of light, for example, a photoinitiator can generate free radicals that cause crosslinking of polymer chains. With radiation crosslinking, initiators and other chemical crosslinking agents may not be necessary. Suitable types of radiation include any radiation that can cause crosslinking of polymer chains such as actinic and particle radiation (e.g., ultraviolet light, X rays, gamma radiation, ion beam, electronic beam, or other high-energy electromagnetic radiation). Crosslinking may be carried out to a level at which, for example, an increase in modulus of the first polymeric composition is observed. At least one of hydrolytic or hydrocarbon resistance may be improved by such crosslinking.

Multi-component fibers useful in the well cement composition and method according to the present disclosure may be added to a well cement composition in any useful amount. For example, the multi-component fibers may be present in the well cement composition in a range from 0.01 percent by weight to 2 percent by weight, based on the total weight of solids in the well cement composition. In some embodiments, the multi-component fibers are present in the well cement composition in an amount up to 2, 1, or 0.5 percent by weight, based on the total weight of solids in the well cement composition.

In some embodiments, the multi-component fibers are present in the well cement composition in an amount less than 1 percent or less than 0.5 percent by weight, based on the total weight of solids in the well cement composition.

Any type of hydraulic well cement may be useful in the well cement composition according to the present disclosure and method disclosed herein. Generally, hydraulic cement used in the oil and gas industry is thinner and exhibits less strength than concrete used for construction due to the requirement that it be highly pumpable in relatively narrow annulus over long distances. Useful hydraulic well cements include portland cements, pozzolanic cements, pozzolan/lime cements, resin or plastic cements, gypsum cements, microfine cements, expanding cements, refractory cements, latex cements, cements for permafrost environments, Sorel cements, cements for carbon dioxide (CO₂) resistance, and combinations thereof. In some embodiments, the hydraulic well cement useful in the well cement composition and method disclosed herein is a portland cement classified by the American Petroleum Institute (API) as Class G or Class H. Portland cement (e.g., Class G or Class H) is a calcined blend or limestone or clay or shale. The high temperature used in the process (e.g., 2600° F. to 3000° F.) fuses the blend into a material referred to as cement clinker, which is ground to a size specified by the grade of cement and combined with a small amount of gypsum. In some embodiments, including embodiments in which the Class G or Class H well cement is used, the hydraulic well cement useful in the well composition and method according to the present disclosure has a maximum particle size of up to 150 micrometers. No additives other than at least one of calcium sulfate or water are interground or blended with the cement clinker during the manufacture of Class G and Class H well cement. Class G and Class H well cement are typically used from the surface to a depth of 8000 feet (2440 meters).

Some crystals typically present in cement clinker are tricalcium silicate, dicalcium silicate, tetracalcium aluminoferrite, tricalcium aluminate, magnesium oxide, and calcium oxide. Class G and Class H well cement can be made to have moderate sulfate resistance (MSR) and high sulfate resistance (HSR). The sulfate resistance is affected by the amount of tricalcium aluminate in the cement since the hydration products of tricalcium aluminate are prone to attack by sulfate ions. In some embodiments, including embodiments in which Class G or Class H well cement is used, the hydraulic well cement useful in the well composition and method according to the present disclosure comprises tricalcium silicate in an amount of at least 48 percent by weight and a combined amount of tetracalcium aluminoferrite and twice the tricalcium aluminate of up to 24 percent by weight based on the total weight of the hydraulic well cement. In some embodiments, including embodiments in which Class G or Class H well cement is used, the hydraulic well cement useful in the well composition and method according to the present disclosure comprises tricalcium silicate in an amount of at least 48, 49, 50, or 55 percent by weight and tricalcium aluminate in an amount of up to 8, 7, 6, or 5 percent by weight based on the total weight of the hydraulic well cement.

Hydraulic well cements can also be classified by their physical properties upon curing. In some embodiments, including embodiments in which Class G well cement is used, the hydraulic well cement useful in the well composition and method according to the present disclosure has a compressive strength of at least 2.1 MPa after being mixed with 44% by weight water, based on weight of the hydraulic well cement (BWOC), and cured for eight hours at 100° F. (38 C.°). In some embodiments, including embodiments in which Class H well cement is used, the hydraulic well cement useful in the well composition and method according to the present disclosure has a compressive strength of at least 2.1 MPa after being mixed with 38% by weight water, BWOC, and cured for eight hours at 100° F. (38 C.°).

Various additives in hydraulic well cement are used to control density, setting time, strength, and flow properties. Examples of useful additives include accelerators, retarders, extenders, weighting agents, dispersants, fluid-loss control agents, free-water control agents, and expansion agents. Accelerators that are useful, for example, for shortening the reaction time required for curing the well cement composition include calcium chloride, sodium chloride, potassium chloride, and sodium silicate. Retarders that are useful, for example, for extending the thickening time of the well cement composition include calcium or sodium lignosulfonates, cellulose derivatives, hydroxycarboxylic acids, organophosphates, maleic anhydride, 2-acrylamido-2-methylpropanesulfonic acid, borax, boric acid, sodium borate, and zinc oxide. Extenders are useful in the well cement composition, for example, to lower the density of the well cement composition and/or to absorb water, thus allowing more water to be added to the cement slurry. Examples of extenders include bentonite, attapulgite, expanded perlite, gilsonite, crushed coal, ground rubber, fly ash, microspheres (e.g., hollow ceramic microspheres or glass microbubbles), microsilica (otherwise known as silica flour), diatomaceous earth, sodium silicate, gypsum, and foaming agents in combination with a gas (e.g., one or more foaming surfactants that generate foam when contacted with a gas such as nitrogen). Weighting agents useful for increasing the density of the well cement composition, for example, include hematite, ilmenite, hausmannite, and barite. Dispersants useful, for example, for improving the flow properties of the well cement composition and lowering the frictional pressures of cement slurries while they are being pumped into the well include polyunsulfonated naphthalene and hydroxycarboxylic acids (e.g., citric acid). Fluid loss additives useful, for example, for controlling water loss from the well cement composition into the formation and preventing solids segregation include bentonite, microsilica, polyvinyl alcohol, synthetic latex, hydroxyethyl cellulose, carboxymethyl hydroxyethyl cellulose, and polyvinyl pyrrolidone. Free-water control agents useful, for example, for preventing solids sedimentation include sodium silicate, biopolymers (e.g., Xanthum gum and Welan gum), and certain alkaline-resistant, high molecular weight synthetic polymers. Expansion agents, which cause the cement to expand somewhat after it has set, include crystalline growth additives (e.g., sodium chloride, potassium chloride, or calcium chloride) and in-situ gas-generating additives (e.g., alumina powder, zinc, magnesium, and iron). Other potentially useful additives to the well cement composition include surfactants, mica, formation-conditioning agents, and defoamers (e.g., siloxanes, silicones and long chain hydroxy compounds such as glycols).

In some embodiments, the well cement composition according to the present disclosure and/or useful in the method disclosed herein include other fibers, different from the multi-component fibers. In some embodiments, the other fibers comprise at least one of metallic fibers, glass fibers, carbon fibers, mineral fibers, or ceramic fibers. In some embodiments, the other fibers are made from any of the materials described above for the second polymeric composition or polyvinyl alcohol, rayon, acrylic, aramid, or phenolics. Other useful materials for the other fibers include natural fibers such as wool, silk, cotton, or cellulose. The other fibers can be useful, for example, as bridging materials to prevent lost circulation of the well cement composition into fractured, unconsolidated, cavernous, or vuggy formations. Using other fibers, which may provide some mechanical property improvement, in combination with the multi-component fibers may lower the cost of the well cement composition, depending on the type of other fiber used. A range of weight ratios of multi-component fibers to the other fibers may be useful. For example, a weight ratio of multi-component fibers to other, different fibers may be in a range from 10:1 to 1:5. Other lost-circulation materials (e.g., cellophane flakes, gilsonite, perlite, and coal) may also be useful in the well cement composition.

The amount of any of the additives described above can be determined by a person skilled in the art, depending on the well, the hydraulic well cement used, and the desired properties. For example, bentonite may be added to the well cement composition in an amount ranging from 0.1 percent to 16 percent, BWOC. Accelerators can be useful in an amount ranging up to 5, 4, 3, 2, or 1 percent, BWOC. Microsilica, which is useful for preventing strength retrogression, for example, in high-temperature wells, decreasing the density, and providing some fluid loss control, can be useful in a range from 1 percent to 100 percent BWOC, 1 percent to 45 percent BWOC, 1 percent to 40 percent BWOC, 3 percent to 40 percent BWOC, 5 percent to 40 percent BWOC, or 10 percent to 40 percent BWOC.

The total amount of additives, including any of those described above, may be present in an amount up to 55, 50, or 45 percent, BWOC. This feature further distinguishes well cement from concrete. Concrete that is useful for civil engineering, for example, typically includes a large proportion of aggregate (e.g., sand and/or gravel). Typically concrete has a ratio of aggregate to cement of greater than 1:1. More typically the ratio of aggregate to cement in concrete is at least 2:1, 3:1, 4:1, or 5:1. The pumpability of concrete is not important as it is for well cement since concrete compositions can be applied in a variety of ways that do not require pumping.

The water utilized in the well cement compositions of the present disclosure can be fresh water, saltwater (e.g., water containing one or more salts dissolved therein), brine (e.g., saturated saltwater), or seawater. Generally, the water can be from any source provided that it does not contain an excess of compounds (e.g., dissolved organics, such as tannins) that may adversely affect other components in the cement composition. Salts in the brine and seawater can act as cure accelerators. A minimum amount of water is necessary to fully hydrate and react with the hydraulic well cement. Further, the water may be present in an amount sufficient to form a pumpable slurry. In some embodiments, the water is present in the well cement composition disclosed herein in an amount in the range of from about 30 percent to about 180 percent, from about 40 percent to about 90 percent, from about 40 percent to about 60 percent, or from about 35 percent to about 50 percent BWOC therein. Neat cement (that is, including no additives) typically requires 35 percent to 50 percent water BWOC, and additional water is required depending on the rest of the additives in the well cement composition. One of ordinary skill in the art can calculate the appropriate amount of water, depending on the well cement composition, for a chosen application.

When it is used in a method of cementing a subterranean well disclosed herein, the hydraulic well cement, multi-component fibers, and optionally other fibers and additives described above may be combined with the water in any order and with any suitable equipment to form the well cement composition ready for pumping or placement into the subterranean well. The multi-component fibers may be added as discrete fibers, and they may also be added as an aggregate of fibers, as described in U.S. Pat. App. Pub. No. 2010/0288500 (Carlson et al.). The well cement composition can be prepared, in some embodiments, by mixing the dry ingredients and water in a jet mixer or a batch mixer. The density of the mixtures is typically closely monitored. The bottom hole temperature, the circulating temperature, and the heat produced by a large amount of cement during hydration can affect the cure time of hydraulic well cement and therefore is also monitored. The necessary volume of cement in a primary cementing operation is typically the volume of the openhole minus the volume of the casing, and excess cement is typically used to allow for washouts and mud contaminations. The methods disclosed herein can be used to cement vertical wells, deviated wells, inclined wells or horizontal wells and may be useful for oil wells, gas wells, and combinations thereof. The subterranean formations that may be cemented include siliciclastic (e.g., shale, conglomerate, diatomite, sand, and sandstone) or carbonate (e.g., limestone) formations.

In some embodiments, including embodiments shown in the Examples, below, the multi-component fibers advantageously improve the tensile strength of the well cement composition relative to a comparative composition that is the same as the well cement composition except that it includes no fibers or it includes fibers other than the multi-component fibers. As shown in Table 1 in the Examples, the relative tensile strength improvement in the presence of the multi-component fibers in Example 1 is about 39% when compared to no fiber (Control Example A2). Also shown in Table 1 in the Examples, the tensile strength improvement relative to Control Example A2 in the presence of the multi-component fibers in Example 1 is about 13% higher than the tensile strength improvement relative to Control Example A2 observed for Comparative Examples D and E, which include fibers having co polyethylene teraphthalate and linear low density polyethylene sheaths, respectively. Also, the tensile strength improvement relative to Control Example A2 in the presence of the multi-component fibers in Example 1 is about 25% higher than the tensile strength improvement relative to Control Example A2 observed for Comparative Example F, which includes fibers having an ethylene vinyl acetate sheath. Thus, the Examples demonstrate that the tensile strength improvement in hydraulic well cement containing bi-component fibers having a sheath of an ethylene-methacrylic acid or ethylene-acrylic acid copolymer is higher than the tensile strength improvement provided by a bi-component fiber having a polyolefin sheath or a sheath having other polar groups. While not wanting to be bound by theory, it is believed that the sheath of an ethylene-methacrylic acid or ethylene-acrylic acid copolymer adheres unexpectedly well to the hydraulic well cement. Furthermore, the data in Table 1 in the Examples show that the flexural strength of hydraulic well cement including bi-component fibers having a sheath of an ethylene-methacrylic acid or ethylene-acrylic acid copolymer is higher than the flexural strength of hydraulic well cement including bi-component fibers having a sheath including other polar groups (e.g., a sheath of ethylene vinyl acetate as shown in Comparative Example F).

### Some Embodiments of the Disclosure

In a first embodiment, the present disclosure provides a well cement composition comprising:

a hydraulic well cement; and

multi-component fibers having external surfaces and comprising at least a first polymeric composition and a second polymeric composition, wherein at least a portion of the external surfaces of the multi-component fibers comprises the first polymeric composition, and wherein the first polymeric composition comprises an ethylene-methacrylic acid or ethylene-acrylic acid copolymer. Written another way, the first embodiment provides the use of these multi-component fibers in a well cement composition. Any of the first to twenty-ninth embodiments, below, can refer to the use of the first embodiment.

In a second embodiment, the present disclosure provides the well cement composition of the first embodiment, wherein the ethylene-methacrylic acid or ethylene acrylic acid copolymer is at least partially neutralized.

In a third embodiment, the present disclosure provides the well cement composition of the first or second embodiment, wherein each of the multi-component fibers has a core and a sheath surrounding the core, wherein the core comprises the second polymeric composition, and wherein the sheath comprises the first polymeric composition.

In a fourth embodiment, the present disclosure provides the well cement composition of any one of the first to third embodiments, wherein the second polymeric composition is not a polyolefin.

In a fifth embodiment, the present disclosure provides the well cement composition of any one of the first to fourth embodiments, wherein the second polymeric composition comprises at least one of a polyamide, a polyester, a polyphenylenesulfide, a polyimide, or a polyetheretherketone.

In a sixth embodiment, the present disclosure provides the well cement composition of any one of the first to fifth embodiments, wherein the first polymeric composition has an elastic modulus of less than 3×10⁵ N/m² at a temperature of at least 80° C. measured at a frequency of one hertz.

In a seventh embodiment, the present disclosure provides the well cement composition of any one of the first to sixth embodiments, wherein the multi-component fibers are non-fusing at a temperature up to at least 110° C.

In an eighth embodiment, the present disclosure provides the well cement composition of any one of the first to seventh embodiments, wherein the first polymeric composition has a softening temperature of up to 150° C.

In a ninth embodiment, the present disclosure provides the well cement composition of any one of the first to eighth embodiments, wherein the second polymeric composition has a melting point higher of at least 130° C.

In a tenth embodiment, the present disclosure provides the well cement composition of any one of the first to ninth embodiments, wherein the difference between the softening temperature of the first polymeric composition and the melting point of the second polymeric composition is at least 10° C.

In an eleventh embodiment, the present disclosure provides the well cement composition of any one of the first to tenth embodiments, wherein the multi-component fibers are present in an amount up to two percent by weight, based on the total weight of solids in the well cement composition.

In a twelfth embodiment, the present disclosure provides the well cement composition of any one of the first to eleventh embodiments, wherein the multi-component fibers are present in an amount up to one percent by weight, based on the total weight of solids in the well cement composition.

In a thirteenth embodiment, the present disclosure provides the well cement composition of any one of the first to twelfth embodiments, wherein the multi-component fibers are present in an amount less than 0.5 percent by weight, based on the total weight of solids in the well cement composition.

In a fourteenth embodiment, the present disclosure provides the well cement composition of any one of the first to thirteenth embodiments, the hydraulic well cement comprises Class G or Class H portland cement.

In a fifteenth embodiment, the present disclosure provides the well cement composition of any one of the first to fourteenth embodiments, wherein the hydraulic well cement comprises tricalcium silicate in an amount of at least 48 percent by weight and a combined amount of tetracalcium aluminoferrite and twice the tricalcium aluminate of up to 24 percent by weight based on the weight of the hydraulic well cement.

In a sixteenth embodiment, the present disclosure provides the well cement composition of any one of the first to fourteenth embodiments, wherein the hydraulic well cement comprises tricalcium silicate in an amount of at least 48 percent by weight and tricalcium aluminate in an amount of up to 8 percent by weight based on the weight of the hydraulic well cement.

In a seventeenth embodiment, the present disclosure provides the well cement composition of any one of the first to sixteenth embodiments, wherein the hydraulic well cement has a maximum particle size of up to 150 micrometers.

In an eighteenth embodiment, the present disclosure provides the well cement composition of any one of the first to seventeenth embodiments, wherein the hydraulic well cement has a compressive strength of at least 2.1 MPa after being mixed with 44% by weight water, based on the weight of the hydraulic well cement, and cured for eight hours at 100° F. (38 C.°).

In a nineteenth embodiment, the present disclosure provides the well cement composition of any one of the first to seventeenth embodiments, wherein the hydraulic well cement has a compressive strength of at least 2.1 MPa after being mixed with 38% by weight water, based on the weight of the hydraulic well cement, and cured for eight hours at 100° F. (38 C.°).

In a twentieth embodiment, the present disclosure provides the well cement composition of any one of the first to nineteenth embodiments, further comprising up to 45 percent by weight silica flour, based on the weight of the hydraulic well cement.

In a twenty-first embodiment, the present disclosure provides the well cement composition of any one of the first to twentieth embodiments, further comprising additives in an amount up to 50 percent by weight, based on the weight of the hydraulic well cement.

In a twenty-second embodiment, the present disclosure provides the well cement composition of the twenty-first embodiment, wherein the additives comprise at least one of accelerators, retarders, extenders, weighting agents, dispersants, fluid-loss control agents, free-water control agents, or expansion agents.

In a twenty-third embodiment, the present disclosure provides the well cement composition of any one of the first to twenty-second embodiments, wherein the well cement composition further comprises other fibers, different from the multi-component fibers.

In a twenty-fourth embodiment, the present disclosure provides the method of the twenty-third embodiment, wherein the other fibers comprise at least one of metallic fibers, glass fibers, carbon fibers, mineral fibers, or ceramic fibers.

In a twenty-fifth embodiment, the present disclosure provides the well cement composition of any one of the first to twenty-fourth embodiments, further comprising water.

In a twenty-sixth embodiment, the present disclosure provides the well cement composition of the twenty-fifth embodiment, wherein the water is present in an amount sufficient to fully hydrate the hydraulic well cement.

In a twenty-seventh embodiment, the present disclosure provides the well cement composition of the twenty-sixth embodiment, wherein the water is present in an amount sufficient to form a pumpable slurry.

In a twenty-eighth embodiment, the present disclosure provides the well cement composition of any one of the twenty-fifth to twenty-seventh embodiments, wherein the well cement composition is cured at a temperature of at least 20° C.

In a twenty-ninth embodiment, the present disclosure provides the well cement composition of any one of the first to twenty-eighth embodiments, wherein the multi-component fibers are in a range from 10 micrometers to 100 micrometers in diameter, and/or wherein the multi-component fibers are in a range from 3 millimeters to 60 millimeters in length.

In a thirtieth embodiment, the present disclosure provides a method of cementing a subterranean well, the method comprising:

introducing the well cement composition of any one of the twenty-fifth to twenty-seventh embodiments into a wellbore;

forming a cured cement in the wellbore.

In a thirty-first embodiment, the present disclosure provides the method of the thirtieth embodiment, wherein the first polymeric composition at least partially adhesively bonds the cured cement.

In a thirty-second embodiment, the present disclosure provides the method of the thirtieth or thirty-first embodiment, wherein the multi-component fibers are non-fusing at a temperature encountered in the subterranean well.

In a thirty-third embodiment, the present disclosure provides the method of any one of the thirtieth to thirty-second embodiments, wherein the second polymeric composition has a melting point higher than a temperature encountered in the subterranean well.

In a thirty-fourth embodiment, the present disclosure provides the method of any one of the thirtieth to thirty-third embodiments, wherein the first polymeric composition has an elastic modulus of less than 3×10⁵ N/m² at a temperature encountered in the subterranean well measured at a frequency of one hertz.

In a thirty-fifth embodiment, the present disclosure provides the method of any one of the thirtieth to thirty-fourth embodiments, wherein the multi-component fibers improve the tensile strength of the well cement composition relative to a comparative composition that is the same as the well cement composition except that it includes polyolefin fibers rather than the multi-component fibers.

In a thirty-sixth embodiment, the present disclosure provides the method of any one of the thirtieth to thirty-fourth embodiments, wherein the multi-component fibers improve the tensile strength of the well cement composition relative to a comparative composition that is the same as the well cement composition except that it does not include the multi-component fibers.

In a thirty-seventh embodiment, the present disclosure provides the method of any one of the thirtieth to thirty-sixth embodiments, wherein the water in the well cement composition is seawater.

In a thirty-eighth embodiment, the present disclosure provides the method of any one of the thirtieth to thirty-seventh embodiments, wherein the wellbore has a casing within it, and wherein introducing the well cement composition comprises placing the well cement composition in the annular space between the casing and the wellbore.

In a thirty-ninth embodiment, the present disclosure provides a cased hole made according to the method of the thirty-eighth embodiment.

In order that this disclosure can be more fully understood, the following examples are set forth. The particular materials and amounts thereof recited in these examples, as well as other conditions and details, should not be construed to unduly limit this disclosure. All percentages are by weight unless otherwise noted.

### EXAMPLES

### Fibers

In the following examples, the following fibers were evaluated in well cement compositions.

Inorgranic Fiber 1 was a synthetic fiber of aluminum oxide, calcium oxide, magnesium oxide, and silica taken from a duct wrap obtained from 3M Company, St. Paul, Minn., under the trade designation “3M FIRE BARRIER DUCT WRAP 615+”.

Inorganic Fiber 2 was a chopped, bulk vitreous magnesium-silicate fiber having a diameter of 4 to 5 mm and obtained from Unifrax I LLC under the trade designation “ISOFRAX 1260C”.

Bicomponent Fiber 1 was a sheath-core bi-component fiber with a core made of nylon 6 (obtained under the trade designation ULTRAMID B-24 from BASF North America, Florham Park, N.J.) and a sheath made of ethylene-acrylic acid ionomer (obtained under the trade designation “AMPLIFY IO 3702” from Dow Chemical, Midland, Mich.). The sheath-core bicomponent fibers were made as described in Example 1 of U.S. Pat. No. 4,406,850 (Hills), except (a) the die was heated to 270° C.; (b) the extrusion die had sixteen orifices laid out as two rows of eight holes, wherein the distance between holes was 12.7 mm (0.50 inch) with square pitch, and the die had a transverse length of 152.4 mm (6.0 inches); (c) the hole diameter was 1.02 mm (0.040 inch) and the length to diameter ratio was 4.0; (d) the relative extrusion rates in grams per hole per minute of the two streams were 0.25 for the core rate and 0.26 for the sheath rate; (e) the fibers were conveyed downwards 36 cm to a quench bath of water held at 25° C., wherein the fibers were immersed in the water for a minimum of 0.3 seconds before being dried by compressed air and wound on a core; and (f) the spinning speed was adjusted by a pull roll to 250 m/min. The fibers were then chopped to a length of 6 mm. The sheath-core volume ratio was 60-40, as determined by microscopic cross-sectional measurement, and the overall fiber diameter was 20 micrometers.

The softening temperature of “AMPLIFY IO 3702” ethylene acrylic acid ionomer was found to be 110° C. when evaluated using the method described in the Detailed Description (page 4, lines 8 to 20). That is, the crossover temperature was 110° C. Also using this method except using a frequency of 1.59 Hz, the elastic modulus was found to be 8.6×10⁴ N/m² at 100° C., 6.1×10⁴ N/m² at 110° C., 4.3×10⁴ N/m² at 120° C., 2.8×10⁴ N/m² at 130° C., 1.9×10⁴ N/m² at 140° C., 1.2×10⁴ N/m² at 150° C., and 7.6×10³ N/m² at 160° C. The melting point of “AMPLIFY IO 3702” ethylene acrylic acid ionomer is reported to be 92.2° C. by Dow Chemical in a data sheet dated 2011. The melting point of “ULTRAMID B24” polyamide 6 is reported to be 220° C. by BASF in a product data sheet dated September 2008. The grade of the “ULTRAMID B24” polyamide 6 did not contain titanium dioxide.

Bicomponent Fiber 2 was obtained from Fiber Innovation Technology, Inc., Johnson City, Tenn., under the trade designation “T-201”. It has a core of polyethylene terephthalate and a sheath of amorphous CoPET (Co Polyethylene Terephthalate). Its dimensions were 3 denier per filament (DPF)×0.25 inch (0.64 cm).

Bicomponent Fiber 3 was obtained from Fiber Innovation Technology, Inc., under the trade designation “T-252”. It has a core of polyethylene terephthalate and a sheath of 128° C. melt linear low density polyethylene (LLDPE). Its dimensions were 3 DPF×0.25 inch (0.64 cm).

Bicomponent Fiber 4 was obtained from MiniFibers, Inc., Johnson City, Tenn., under the product code RADEW-015BRR-500. It has a core of polypropylene reported to have a melting point of 165° C. and a sheath of ethylene vinyl acetate reported to have a melting point of 100° C. Its dimensions were 2 DPF 5 mm in length.

### Cement Slurries

Cement slurries were prepared as follows: a dry blend of portland G obtained from Sanjel Corporation, Calgary, Alberta, Canada, and silica flour obtained from Unimin Corp., Troy Grove, Ill., (40% based on weight of cement) was mixed with 45 wt % (based on weight of dry blend) deionized water and 0.5 wt % (based on weight of dry blend) pre hydrated Wyoming bentonite (obtained from M-I SWACO, Houston, Tex., a Schlumberger Company, under the trade designation “M-I GEL”) with a constant speed mixer (Chandler Engineering Model 3060) following the API Specification 10A procedure, 23^{rd} Edition, April 2002 (ANSI/API 10A/ISO 10426-1-2001). Then 0.2 wt % (based on weight of dry blend) fibers described above were added to the mixer (except for Control Example A1 and A2) and mixed in at 12,000 rpm for 50 seconds. One type of fiber was used for each Example or Comparative Example. The fiber type for each Example or Comparative Example is shown in Table 1, below. Three 500 mL batches were prepared per fiber type. These three batches were blended in a larger beaker using a rubber spatula.

Control Example A1 and Comparative Examples B and C were all prepared at the same time from the same batch of cement. Control Example A2, Comparative Examples D, E, and F, and Example 1 were prepared at the same time from the same batch of cement. But Control Example A1 and Comparative Examples B and C were prepared from a different cement batch at a different time than Control Example A2, Comparative Examples D, E, and F, and Example 1.

Cured cement specimens without (control examples) and with the fibers were prepared and evaluated for tensile and flexural strength according to the procedures described below.

### Tensile Strength (Split Test)

Cylindrical molds (4.13 cm (1.625 in) inside diameter×26.7 cm (10.5 in)) made of polyvinylchloride (PVC) pipe sections capped at the bottom with plugs made from polytetrafluoroethylene (PTFE) were filled halfway and the slurry was puddled using a glass rod. Then the molds were filled to slightly overflowing and the slurry was puddled again. Finally, the excess slurry was stroked off and the molds covered with plastic paraffin film to prevent excessive water loss. Rubber bands were used to make sure the plastic paraffin film stayed in place overnight. The next day all molds were placed, uncovered, in a water bath at 20° C. After one month the specimens, still inside the molds, were cut to size using a power saw, discarding 1.9 cm (0.75 in) of the long end portions. Then, the specimens were de-molded by cutting the PVC pipe with a power band saw. Cured cement specimens cut to length (L/D=1 or 2) were evaluated for tensile (split test) strength following the procedure outlined in ASTM C496/C496M. A displacement rate of 0.25 mm/min was applied while load values were measured and recorded. A displacement controlled load cell (obtained from Instron, Norwood, Mass., under the trade designation “INSTRON 5581”) with a 5,000 kgf max load cell was used. The evaluations were stopped soon after the specimen failed. Wood bearing strips (tongue depressors) were used as bearing strips for the split tests. Four to five specimens per type of fiber were used in the tests. Average values and corresponding coefficient of variance (COV) were determined and reported in Table 1, below.

### Three Point Bending (Flexural) Test

Rectangular cross sectional molds (2.86 cm (1.125 in)×3.18 cm (1.25 in)×26.7 (10.5 in) or 2.86 cm (1.125 in)×3.18 cm (1.25 in)×15.2 cm (6.0 in), made of aluminum pipe sections lined inside with PTFE tape obtained from 3M Company under the trade designation “3M PTFE FILM TAPE 5490” and sealed at the bottom with tape obtained from 3M Company under the trade designation “SCOTCH 893 TAPE” were filled with cement slurry, following the procedure described under Unconfined Compressive Strength and Split tests and set to cure at 20° C. After one month the specimens were de-molded and evaluated for flexural strength using a displacement controlled load frame (obtained from MTS Systems Corporation, Eden Prairie, Minn., under the trade designation “MTS SINTECH 1/G”) with a 453 kgf (1000 lb) max load cell, and following the procedure outlined in ASTM C293/C293M. A displacement rate of 0.25/min was used. Four to five specimens per type of fiber were used in the tests. Average values and corresponding coefficient of variance (COV) were determined and reported in Table 1, below.

TABLE 1

| | | Tensile | Flexural | Post-Flexural |
|---|---|---|---|---|
| | | strength | strength | Axial strength |
| | | MPa/psi | MPa/psi | max load kg/lb |
| Example | Fiber | (COV) | (COV) | (COV) |
| Control | None | 3.27/474 | 6.73/976 | *NT |
| Example A1 | | (0.24) | (0.12) | |
| Comparative | Inorganic | 3.27/474 | 5.99/869 | *NT |
| Example B | fiber 1 | (0.08) | (0.14) | |
| Comparative | Inorganic | 2.91/422 | 5.49/796 | *NT |
| Example C | fiber 2 | (0.02) | (0.16) | |
| Control | None | 2.74/398 | 5.01/726 | *NT |
| Example A2 | | (0.11) | (0.16) | |
| Comparative | Bicomponent | 3.46/502 | 5.95/863 | *NT |
| Example D | fiber 2 | (0.09) | (0.09) | |
| Comparative | Bicomponent | 3.45/500 | 5.98/865 | *NT |
| Example E | fiber 3 | (0.02) | (0.09) | |
| Comparative | Bicomponent | 3.12/452 | 5.90/855 | 5.17/11.4 |
| Example F | fiber 4 | (0.06) | (0.02) | (0.43) |
| Example 1 | Bicomponent | 3.80/551 | 5.98/868 | 5.99/13.2 |
| | fiber 1 | (0.08) | (0.12) | (0.31) |

*NT = not tested;
COV = coefficient of variation

For Control Examples A1 and A2 and Comparative Examples B through E the following failure patterns were observed. In the split tests, a fracture was created in the midsection, length wise, splitting each specimen in two distinct halves. In the three point bending tests, a fracture was created at the point where the center load is applied, separating the specimen into two sections. However, Comparative Example F and Example 1 showed a different failure pattern in both of these evaluations. With Comparative Example F and Example 1, a fracture was created in the midsection, but no splitting in two distinct halves occurred. Instead, both halves remained strongly attached making it difficult to see the fracture. This attachment remained not only while still in the load frame, but also while being handled (split tests) or even held in cantilever afterwards (three point flexural tests).

In order to further evaluate fractured samples of Example 1 and Comparative Example F special grips were designed and fabricated and post-flexural axial tests were carried out to quantify the force needed to pull the specimen's halves apart. The post-flexural axial tests were carried out using the already fractured specimens, which were kept in a water bath at room temperature for three months. The method described below was used.

During the post-flexural axial test, the fibers within Example 1 and Comparative Example F did not all break. Instead, they seem to have elongated as the halves were pulled apart and appeared stretched between the separated halves. However, as Post Flexural Axial test results show in Table 1, 15.7% more force was required to separate the two halves of fractured specimens of Example 1 when compared to fractured specimens of Comparative Example F.

### Post-Flexural Axial Test

A displacement controlled load frame (obtained from Instron, Norwood, Mass., under the trade designation “INSTRON 1122”) with a 100 kgf max load cell was used to run pure axial tests on the ‘fractured’ cement specimens Comparative Example F and Example 1. Custom made grips were used to hold the already ‘fractured’ specimens in place, that is, tightly attached to the load frame top and bottom fixtures while the latter separated at a displacement rate of 0.25 mm/min. The evaluation was stopped when a displacement of 2 to 3 mm was achieved. Load values are measured and recorded, and the maximum load is shown in Table 1, above.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A well cement composition comprising:
a hydraulic well cement; and
multi-component fibers having external surfaces and comprising at least a first polymeric composition and a second polymeric composition, wherein at least a portion of the external surfaces of the multi-component fibers comprises the first polymeric composition, and wherein the first polymeric composition comprises an ethylene-methacrylic acid or ethylene-acrylic acid copolymer.

2. The well cement composition of claim 1, wherein the second polymeric composition is not a polyolefin.

3. The well cement composition of claim 1, wherein the second polymeric composition comprises at least one of a polyamide, a polyester, a polyphenylenesulfide, a polyimide, or a polyetheretherketone.

4. The well cement composition of claim 1, wherein the first polymeric composition has an elastic modulus of less than 3×10⁵ N/m² at a temperature of at least 80° C. measured at a frequency of one hertz.

5. The well cement composition of claim 1, wherein the multi-component fibers are non-fusing at a temperature up to at least 110° C.

6. The well cement composition of claim 1, wherein the first polymeric composition has a softening temperature of up to 150° C., wherein the second polymeric composition has a melting point of at least 130° C., and wherein the difference between the softening temperature of the first polymeric composition and the melting point of the second polymeric composition is at least 10° C.

7. The well cement composition of claim 1, wherein each of the multi-component fibers has a core and a sheath surrounding the core, wherein the core comprises the second polymeric composition, and wherein the sheath comprises the first polymeric composition.

8. The well cement composition of claim 1, wherein the multi-component fibers are present in an amount up to one percent by weight, based on the total weight of solids in the well cement composition.

9. The well cement composition of claim 1, further comprising additives in an amount up to 50 percent by weight, based on the weight of the hydraulic well cement, wherein the additives comprise at least one of accelerators, retarders, extenders, weighting agents, dispersants, fluid-loss control agents, free-water control agents, expansion agents, or other fibers, different from the multi-component fibers.

10. The well cement composition of claim 1, wherein the hydraulic well cement comprises Class G or Class H portland cement.

11. The well cement composition of claim 1, wherein the well cement composition further comprises water.

12. A method of cementing a subterranean well, the method comprising:
introducing the well cement composition of claim 11 into a wellbore; and
forming a cured cement in the wellbore.

13. The method of claim 12, wherein the multi-component fibers are non-fusing at a temperature encountered in the subterranean well.

14. The method of claim 12, wherein the second polymeric composition has a higher melting point than a temperature encountered in the subterranean well.

15. The method of claim 12, wherein the wellbore has a casing within it, and wherein introducing the well cement composition comprises placing the well cement composition in the annular space between the casing and the wellbore.

16. The method of claim 12, wherein the first polymeric composition at least partially adhesively bonds the cured cement.

17. The well cement composition of claim 11, wherein the water is present in an amount sufficient to form a pumpable slurry.

18. The well cement composition of claim 1, wherein the ethylene-methacrylic acid or ethylene acrylic acid copolymer is at least partially neutralized.

19. The well cement composition of claim 1, wherein the well cement composition further comprises other fibers, different from the multi-component fibers, and wherein the other fibers comprise at least one of metallic fibers, glass fibers, carbon fibers, mineral fibers, or ceramic fibers.

20. The well cement composition of claim 1, wherein the hydraulic well cement has a maximum particle size of up to 150 micrometers.
